(19) United States
(12) Patent Application Publication
(10) Pub. No.: US 2008/0244733 A1
(43) Pub. Date: Oct. 2, 2008

(54) Information management system, information management method, and computer program product

(76) Inventors: Kohki Katoh, Tokyo (JP); Haruhiro Tohda, Saitama (JP); Morio Takahashi, Kanagawa (JP); Fumio Itoku, Saitama (JP); Fujio Satoh, Kanagawa (JP)

Correspondence Address: LATHROP & GAGE LC, 1845 S. NATIONAL, P.O. BOX 4288, SPRINGFIELD, MO, 65101, US

(21) Appl. No.: 12/076,190

(22) Filed: Mar. 14, 2008

(30) Foreign Application Priority Data
Mar. 16, 2007 (JP) 2007-069276

(51) Int. Cl. H04L 9/32; G06F 15/16

(52) U.S. Cl. 726/18; 709/201

(57) ABSTRACT

An information management system includes a management terminal, and a production base terminal, an installation terminal, a recycling base terminal or a reproduction base terminal connected to the management terminal via a network. Upon receipt of product information and recording medium information from the production base terminal and the customer information from the installation base terminal, the management terminal stores therein the information, and selects a recycling base or a reproduction base based on the information. The management terminal transmits at least one of the product information and the recording medium information to the recycling base terminal or the reproduction base terminal.

### CROSS-REFERENCE TO RELATED APPLICATIONS

The present application claims priority to and incorporates by reference the entire contents of Japanese priority document 2007-069276 filed in Japan on Mar. 16, 2007.

### BACKGROUND OF THE INVENTION

1. Field of the Invention

The present invention relates to an information management system, an information management method, and a computer program product.

2. Description of the Related Art

Recently, an information recording medium, such as a hard disk (HDD), is installed on various types of products. Among such products are image forming apparatuses such as copiers and printers. The information recording medium often stores therein confidential information including document information, image information, and customer information. Having been used by customers, these products are generally collected by a collector and transporter, and properly processed by recycling and reuse vendors. However, some products are not properly recycled or reused, and illegally dumped or parts thereof and the like are pilfered after being collected to be processed, which may lead to information leakage from a recording medium installed thereon.

Thus, there is a need of a technology for reliable and proper processing of a recording medium when a product on which the recording medium has been installed is replaced, and notifying, if necessary, an ex-user of the product or the like of a processing result of the recording medium. For example, Japanese Patent Laid-Open Publication No. 2002-336832 discloses a conventional technology for managing a reproduction process and the like of used products using a computer terminal.

However, in the conventional technology, information on used products to be recycled or reused is not thoroughly provided to recycling and reuse vendors and the like. Therefore, upon receipt of a used product, such vendors often cannot find where a recording medium is installed on the used product. Accordingly, the recording medium cannot be processed reliably enough.

Even if the recording medium is processed, information on the processing result is not sufficiently provided to the ex-user of the product or the like, and also the record of the processing result is not managed adequately. In a product with a recording medium, the recording medium may be replaced due to failure, or an additional new one may be installed on the product after purchasing it. Accordingly, management on a recording medium that has been replaced or added is also required.

### SUMMARY OF THE INVENTION

It is an object of the present invention to at least partially solve the problems in the conventional technology.

According to an aspect of the present invention, there is provided an information management system including a management terminal, and at least one terminal that is connected to the management terminal via a network. The terminal includes a first terminal that receives at least product information on a product and recording medium information; a second terminal that receives at least customer information on a customer using the product; a recycling base terminal that receives at least recycling information on recycling of at least one of a used product and a recording medium attached to the used product; and a reproduction base terminal that receives at least reproduction information on reproduction of at least one of a used product and a recording medium attached to the used product. The management terminal includes a first receiving unit that receives the product information and the recording medium information from the first terminal; a first storage unit that stores therein information received by the first receiving unit; a second receiving unit that receives the customer information from the second terminal; a second storage unit that stores therein information received by the second receiving unit; a selecting unit that selects, when the second receiving unit receives information from the second terminal, any one of the recycling base terminal and the reproduction base terminal as a selection terminal based on the information stored in the first storage unit; and a transmitting unit that transmits at least one of the product information and the recording medium information to the selection terminal.

According to an aspect of the present invention, there is provided an information management method applied to an information management system including a management terminal and at least one terminal that is connected to the management terminal via a network. The terminal includes a first terminal that receives at least product information on a product and recording medium information, a second terminal that receives at least customer information on a customer using the product, a recycling base terminal that receives at least recycling information on recycling of at least one of a used product and a recording medium attached to the used product, and a reproduction base terminal that receives at least reproduction information on reproduction of at least one of a used product and a recording medium attached to the used product. The information management method includes, in the management terminal, first receiving the product information and the recording-medium information from the first terminal; first storing information received at the first receiving; second receiving the customer information from the second terminal; second storing information received at the second receiving; selecting, when information is received from the second terminal at the second receiving, any one of the recycling base terminal and the reproduction base terminal as a selection terminal based on the information stored at the first storing; and transmitting at least one of the product information and the recording medium information to the selection terminal.

According to still another aspect of the present invention, there is provided a computer program product that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an information management system according to an embodiment of the present invention;

FIG. 2 is a schematic diagram for explaining a delivery route of a product and a recording medium;

FIG. 3 is an example of a data table set in a product information storage unit;

FIG. 4 is an example of a data table set in a customer information storage unit;

FIG. 5 is an example of a data table set in a recycling base storage unit;

FIG. 6 is an example of a data table set in a recycling processing information storage unit;

FIG. 7 is a flowchart of a process of storing data from a production base terminal to a management terminal;

FIG. 8 is a schematic diagram of an example of an input template screen displayed on a display of the production base terminal;

FIG. 9 is a flowchart of a process of storing data from an installation base terminal to the management terminal;

FIG. 10 is a schematic diagram of an example of an input template screen displayed on a display of one of installation terminals as the installation base terminal;

FIG. 11 is a flowchart of a process for selecting a recycling base;

FIG. 12 is a flowchart of a process from extraction of a product nearing the end of its service life to storage of data related to processing of the product;

FIG. 13 is a flowchart of a process of delivering new pickup schedule information to a terminal of a client who desires a processing (result) certificate of the recording medium;

FIG. 14 is a flowchart of a process for transmitting information on a product and a recording medium collected to a reproduction base terminal and a recycling base terminal;

FIG. 15 is a flowchart of a process for transmitting an information processing result;

FIG. 16 is a schematic diagram of a login screen displayed on a display of one of the installation terminals as a client terminal;

FIG. 17 is a schematic diagram of a confirmation screen displayed on the display of the client terminal;

FIG. 18 is a flowchart of a process related to storage of information input from the reproduction base terminal and the recycling base terminal;

FIG. 19 is a flowchart of a process related to storage of information input from the recycling base terminal;

FIG. 20 is a flowchart of a process related to delivery of a processing certificate in response to a request from the reproduction base terminal and the recycling base terminal;

FIG. 21 is a flowchart of a process related to a production of the processing certificate in response to a request from the recycling base terminal;

FIG. 22 is a flowchart of a process related to extraction and delivery of the processing certificate in response to a request from the client terminal; and

FIG. 23 is a schematic diagram of an example of a notification screen for the processing certificate.

### DETAILED DESCRIPTION OF THE PREFERRED EMBODIMENTS

Exemplary embodiments of the present invention are explained in detail below with reference to the accompanying drawings.

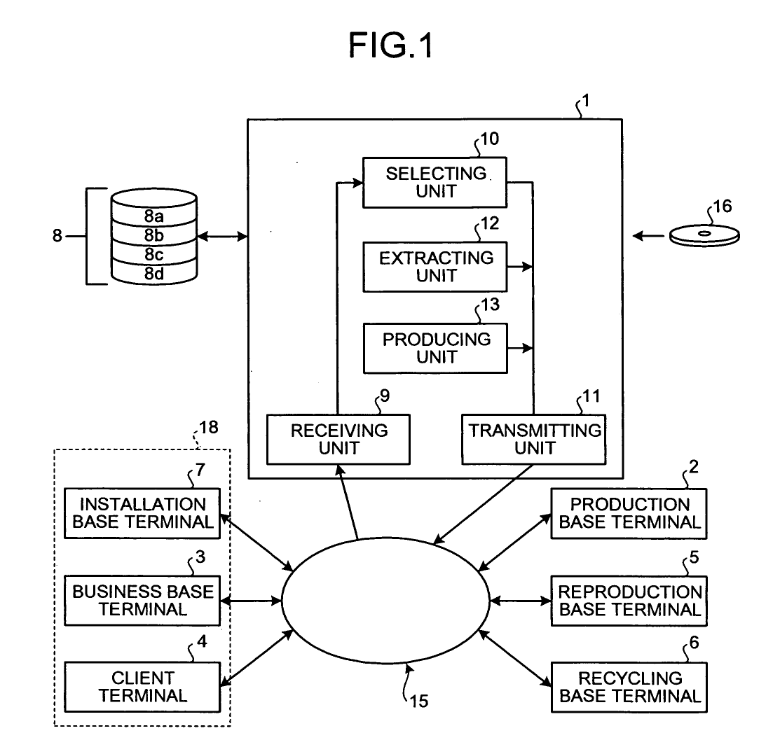

An information management system according to an embodiment of the present invention, as shown in FIG. 1, includes a management terminal 1 and a plurality of terminals that can be accessed to the management terminal 1 by connecting through a network 15 such as the Internet, for example, a local area network (LAN) and a public network. The management terminal 1 and the terminals can be a personal computer having a display device (not shown).

The terminals include a production base terminal 2, an installation terminal 18, a recycling base terminal 6, and a reproduction base terminal 5. The production base terminal 2 at least inputs product information related to a product 20 produced, and information on a recording medium 21 (hereinafter, “recording medium information”) installed on the product 20. The installation terminal 18 at least inputs customer information related to a customer who uses the product 20. The recycling base terminal 6 at least inputs information related to recycling of at least one of a used product 20A and a used recording medium 21A delivered. The reproduction base terminal 5 at least inputs information related to reproduction of at least one of the used product 20A and the used recording medium 21A delivered.

The installation terminal 18 includes a business base terminal 3 installed at a business base, a terminal (hereinafter, “client terminal”) 4 of a customer who is using the product 20, and an installation base terminal 7 installed at an installation base that supplies the product 20 to a consignee. The business base terminal 3 is a service terminal installed at the business base where maintenance and inspection for the product 20 installed for the customer by the installation base take place. However, when the installation base carries out the similar operation to the business base, the business base terminal 3 is not required. In this case, the installation base terminal 7 has a function of receiving information input from the business base terminal 3 or information transmitted from the management terminal 1. In this embodiment, the client terminal 4 is a constituent element of the installation terminal. However, when the client terminal 4 is not included in the configuration, information input from the client terminal 4 may be input from the business base terminal 3 or the installation base terminal 7, and the information received by the client terminal 4 may be received by the business base terminal 3 or the installation base terminal 7.

The management terminal 1 can be a server, and a computer program (information management program) is downloaded via the network 15 such as the Internet or installed from a recording medium 16 such as an optical disk in which the program is recorded. When the information management program is installed on the management terminal 1, the management terminal 1 operates so as to execute a step of receiving at least product information and recording medium information from the production base terminal 2, a step of storing therein the information received from the production base terminal 2, a step of receiving customer information from the installation terminal 18, a step of storing therein the information received from the installation terminal 18, a step of selecting a recycling base or a reproduction base based on the accumulated information, and a step of transmitting at least one of the product information and the recording medium information to a terminal at the recycling base or the reproduction base selected at the selection step.

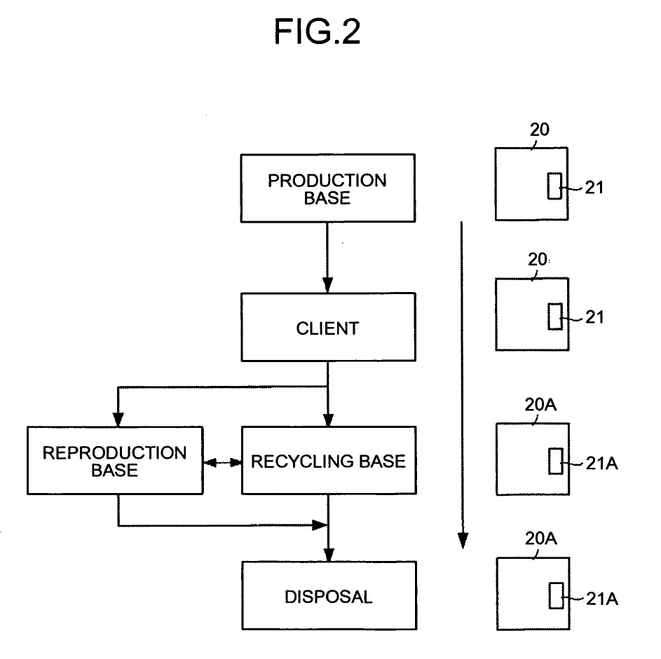

As shown in FIG. 2, the product 20 is delivered from a production base to a client who is a customer using the product. After being delivered and used for a predetermined time, the product 20 and the recording medium 21 become the used product 20A and the used recording medium 21A, when the customer no longer requires them. The used product 20A and the used recording medium 21A are then loaded on a transferring unit such as recycling truck, and transferred to a recycling base or a reproduction base to be collected. At the recycling base or the reproduction base, the used product 20A and the used recording medium 21A are disassembled and separated. Those members and products that can be used again are processed for reuse, and those members and products that can be reutilized for other usage are processed for recycling, and a part of the members and the like that cannot be reutilize for any other usage are processed for disposal.

The management terminal 1 includes a receiving unit 9, an information storage unit 8, a selecting unit 10, and a transmitting unit 11. The receiving unit 9 receives product information and recording medium information transmitted from the production base terminal 2, and customer information transmitted from the business base terminal 3 and the installation base terminal 7, among the installation terminals 18. The information storage unit 8 includes a product information database (product information DB) 8A stores therein information received from the production base terminal 2, a customer information database (customer information DB) 8B stores therein information received from the business base terminal 3 and the installation base terminal 7, a recycling base storage unit (hereinafter, “recycling base information DB”) 8C in which specific information on the reproduction base terminal 5 and the recycling base terminal 6 are stored therein, and a recycling information storage unit (hereinafter, “recycling processing information DB”) 8D that stores information related to reproduction and recycling of at least one of the used product 20A and the used recording medium 21A transmitted from the reproduction base terminal 5 and the recycling base terminal 6. The selecting unit 10 selects a recycling base or a reproduction base based on the information accumulated in the information storage unit 8. The transmitting unit 11 at least transmits at least one of the product information and the recording medium information to the reproduction base terminal 5 or the recycling base terminal 6 at the reproduction base or the recycling base selected by the selecting unit 10. In this embodiment, the information transmitted from the production base terminal 2 and the installation terminal 18 is received by one receiving unit 9. However, an individual receiving unit can be provided respectively.

The selecting unit 10 has a function of selecting a recycling base or a reproduction base, when the receiving unit 9 receives information from the installation terminal 18. The selecting function includes:

to select a recycling base or a reproduction base, when the receiving unit 9 receives information related to the used product 20A from the installation base terminal 7.

to select a recycling base, when the receiving unit 9 receives the information related to the recording medium 21A detached from the product 20.

to select a recycling base or a reproduction base, when the receiving unit 9 receives information related to at least one of the recording medium 21 installed on the product 20 by a replacement operation and information related to the recording medium 21 added to the product 20.

to select a recycling base or a reproduction base, when the receiving unit 9 receives information that at least one of the product 20 including the recording medium 21 installed by a replacement operation and the product 20 including the recording medium 21 being added becomes no longer used.

In the product information DB 8a, information on the product 20 and a single or a plurality of recording media 21 installed on the product is associated with the product information, and stored and accumulated as a data table.

The management terminal 1 includes an extracting unit 12 that extracts information related to the product 20, which becomes no longer used after a predetermined time, based on the product information accumulated in the product information DB 8a and the customer information accumulated in the customer information DB 8b. The extracting unit 12 extracts different information depending on whether the recording medium 21 is installed on the product 20. The extracting unit 12 also extracts different information depending on whether a client requires a recording medium processing certificate.

The management terminal 1 includes an information transmission function that repeatedly transmits information extracted by the extracting unit 12 at a predetermined time interval, to the client terminal 4 among the installation terminals 18, using the transmitting unit 11. When the client terminal 4 is not included, the information may be transmitted repeatedly at a predetermined time interval, to the business base terminal 3 or the installation base terminal 7.

The management terminal 1 includes a producing unit 13 that produces a processing certificate of the recording medium 21, based on the product information and the recording medium information accumulated in the product information DB 8a, and the customer information accumulated in the customer information DB 8b. The producing unit 13 produces the processing certificate of the recording medium 21, depending on whether a customer (client) requires the recording medium processing certificate. The management terminal 1 includes a transmitting unit that transmits a processing completion result of the recording medium 21 depending on whether the customer requires the recording medium processing certificate, at least to the client terminal 4, among the installation terminals 18. When the client terminal 4 is not included, the processing completion result of the recording medium 21 may be transmitted to the business base terminal 3 or the installation base terminal 7. In the embodiment, the transmitting unit 11 is also used for this transmitting unit. However, an individual transmitting unit can be provided respectively.

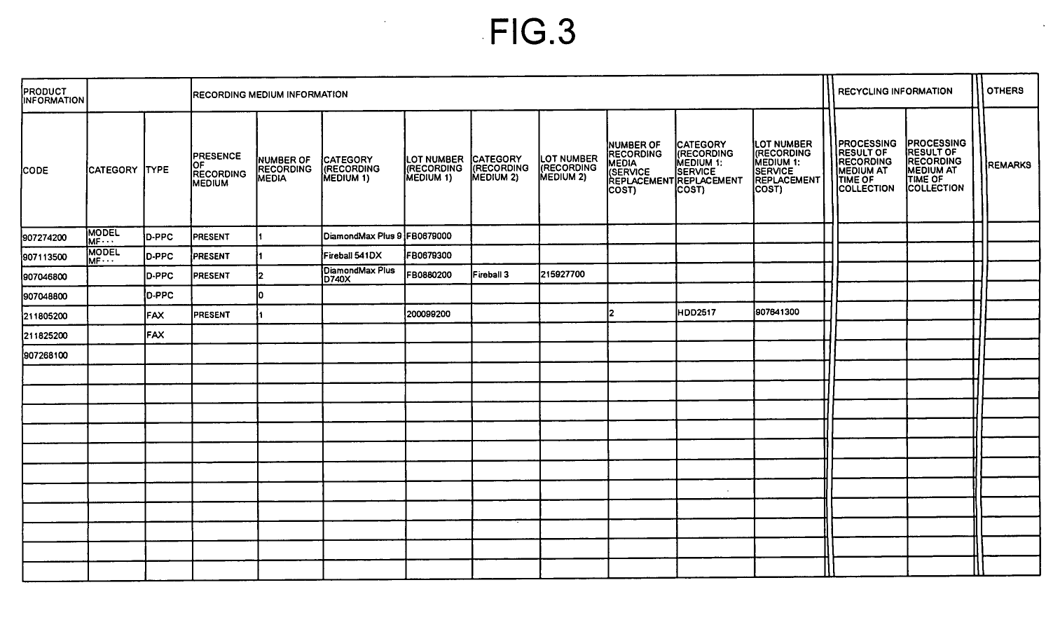

FIG. 3 is an example of a data table set in the product information DB 8a. The table stores therein the product information, the recording medium information, and the recycling information that are associated with each other. In the data table, input fields such as code, category, and type of each product are set as the product information. The data table stores and accumulates therein data corresponding to each of the input field.

In the data table, input fields, such as presence of a recording medium (whether the recording medium 21 is installed), the number of recording media, category, lot number, the number of recording media (replacement information), category name and lot number of a recording medium after being replaced, and information on an additional recording medium with category and lot number thereof, are set as the recording medium information. Data that corresponds to each of the input field is stored and accumulated therein.

In the data table, input fields such as a processing result of the recording medium at the time of collection, a name of recycling/reproduction base, a location of the recycling/reproduction base, a delivery date to the recycling/reproduction base, a processing start date and a person in charge of processing the used product, a processing method, a processing start date, a person in charge of processing the collected recording medium, material (such as photograph) for each recording medium before being processed, a processing completion time (conducted date) of the recording medium, a material (such as photograph) for a processing certificate of the recording medium, a processing completion date of the used product, usage of the used product, and a processing result of the recording medium are set as the recycling information. Data that corresponds to each of the input field is stored and accumulated therein.

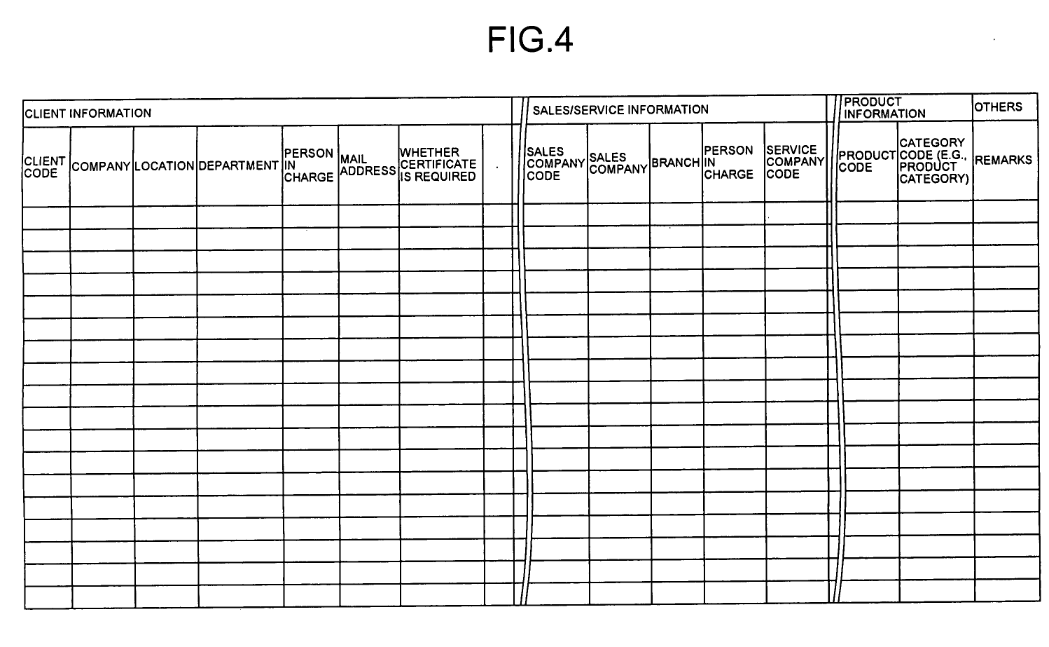

FIG. 4 is an example of a data table set in the customer information DB 8b. In the table, client information, sales/service information, and product information are associated with one another and stored. In the data table, input fields, such as client code, company, location, department, person in charge and his/her mail address, whether recording medium processing certificate is required, desired recording medium processing method, and client's personal ID information, are set as the customer information. Data that corresponds to each of the input field is stored therein. The client's personal ID information is used for access from the client terminal 4 to prevent unauthorized access and to specify the client terminal 4 that has made the access. When the client terminal 4 is not included in the system, the client's personal ID information field becomes unnecessary. It should be noted that the client's personal ID information can be stored for other usages.

Input fields, such as sales company code, sales company, branch of the sales company, person in charge of the sales company, service company code, service company, branch of the service company, a person in charge of the service company, installation date and time of product, date of visiting client (service replacement date), time of visiting the client (service replacement time), estimated collection date, collection time, collector, total output number of product, and processing result of a recording medium at the time of collection, are set as the sales/service information. Data that corresponds to each of the input field is stored and accumulated therein. Input fields, such as product code and category code, are set as the product information. Data that corresponds to each of the input field is stored and accumulated therein. The sales/service information is input from the business base terminal 3 and the installation base terminal 7.

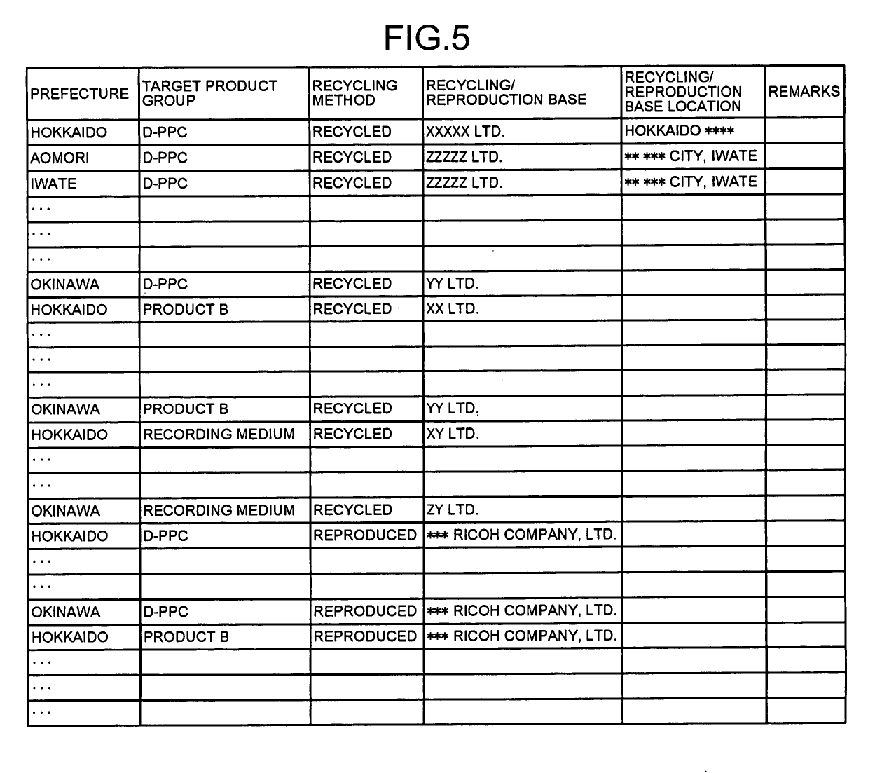

FIG. 5 is an example of a data table set in the recycling base information DB 8c. In the table, the specific information on the reproduction base terminal 5 and the recycling base terminal 6 are associated with each other and stored. In the data table, input fields, such as prefecture (location information of each base), target product group (product group to be processed or to be reproduced), recycling method, recycling/reproduction base, and recycling/reproduction base location, are set as the specific information. Data that corresponds to each of the input field is stored and accumulated therein.

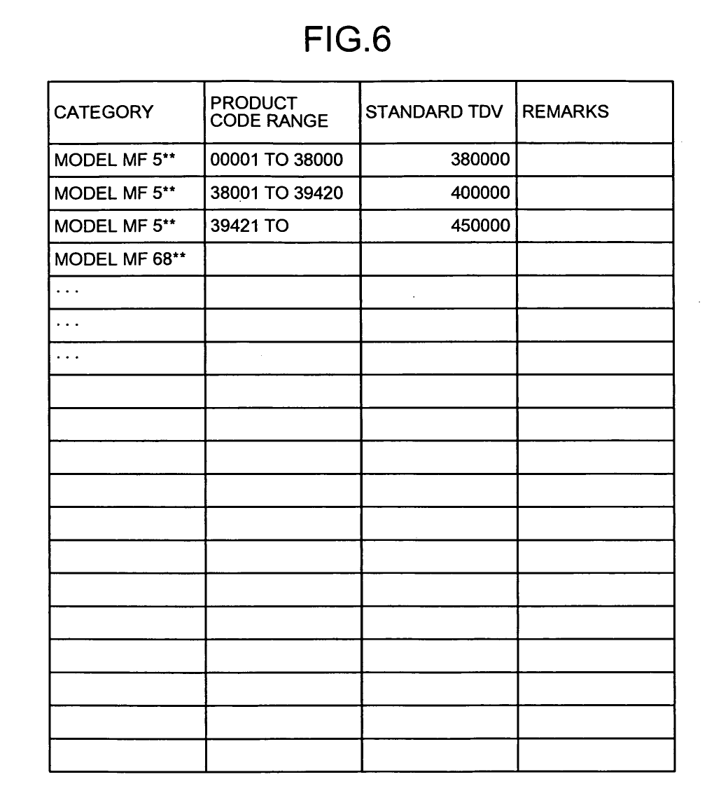

FIG. 6 is an example of a data table set in the recycling processing information DB 8d. In the table, information related to reproduction and recycling of the used product 20A and the used recording medium 21A transmitted from the reproduction base terminal 5 or the recycling base terminal 6 are associated with each other and stored. In the data table, input fields, such as category, product code range, and standard total document volume, i.e., standard total output number (TDV), are set as the information related to reproduction and recycling. Data that corresponds to each of the input field is stored and accumulated therein. The standard TDV indicates a total output number that becomes the standard for determining the reproduction/recycling. If the product category to be determined is only used for recycling, for example, the standard TDV becomes any number such as “0” or “1”.

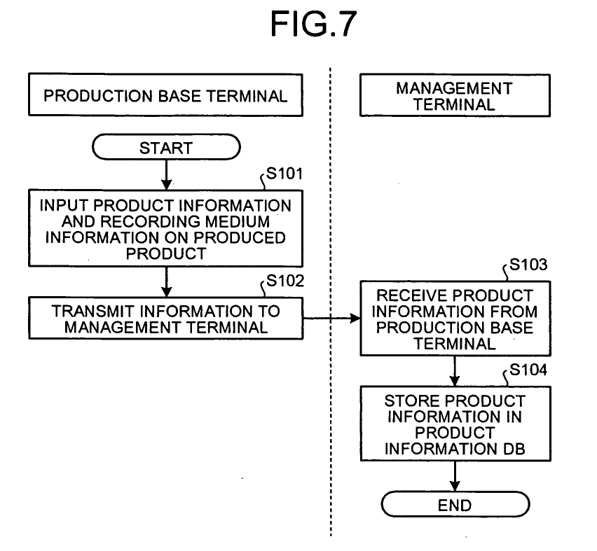

FIG. 7 is a flowchart of a process performed at the production base terminal 2 and the management terminal 1. At step S101, product information related to the product 20 and information related to the recording medium 21 installed on the product 20 are input in the production base terminal 2. A category code (such as category number) and a product code (serial number or lot number) are input as the product information. Whether the recording medium is present (installed), the number of recording media (when present), a category code (such as category number) of each recording medium, and a product code of each recording medium (serial number or lot number) are input as the recording medium information.

At step S102, each of the input information, i.e., the product information and the recording medium information, is transmitted to the management terminal 1 via the network 15.

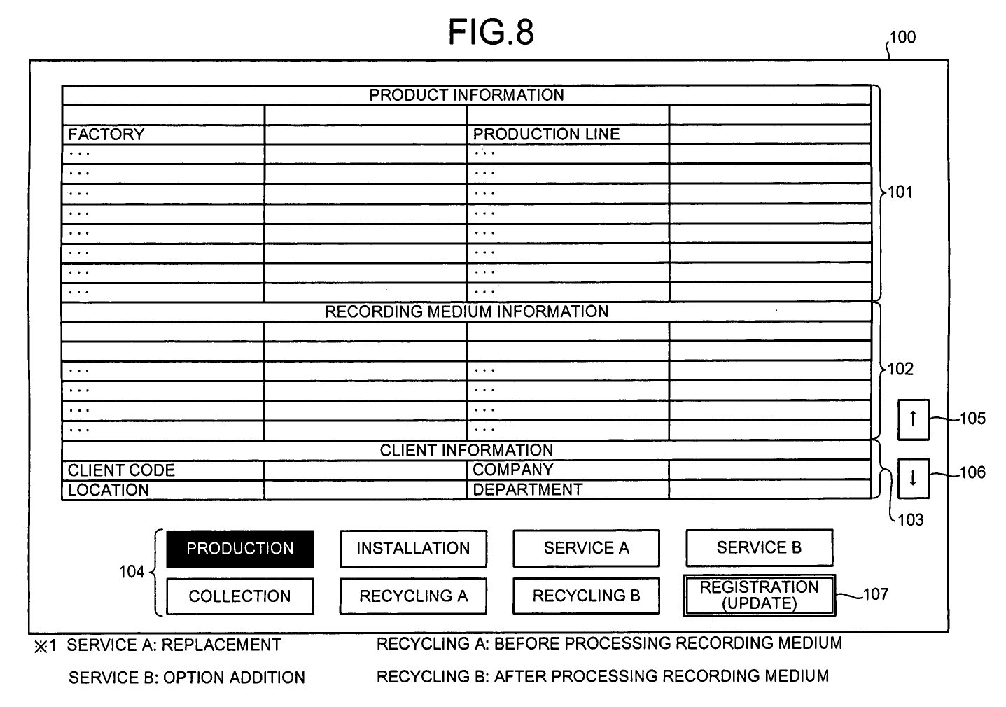

To perform steps S101 and S102, an input template screen 100 as shown in FIG. 8 is displayed on a display of the production base terminal 2. On the input template screen 100, input fields 101, 102, and 103 where the product information, the recording medium information, and the client information are input are displayed. Under the input fields 101, 102, and 103, a selection button group 104 for selecting various conditions, and scroll keys 105 and 106 are displayed. The scroll key 105 is used to scroll to the previous page or to the previous line. The scroll key 106 is used to scroll to the next page or to the next line.

In the input template screen 100, when an operator selects and presses a button that corresponds to each step, for example, by a mouse connected to the production base terminal 2 or by operating keys, the pressed button is highlighted, i.e., input item is highlighted and displayed. Accordingly, the operator is prompted to input data for the input item displayed. Then, the operator inputs data and operates a registration button 107 of the selection button group 104, thereby completing the registration process. When the registration process is completed, the input data is transmitted to the management terminal 1. In FIG. 8, *1 explains the function of each button in the selection button group 104.

The process at steps S103 and S104 in FIG. 7 is performed at the side of the management terminal 1. At step S103, the product information is received from the production base terminal 2. At step S104, the received product information is stored in the data table of the product information DB 8a, and the process ends.

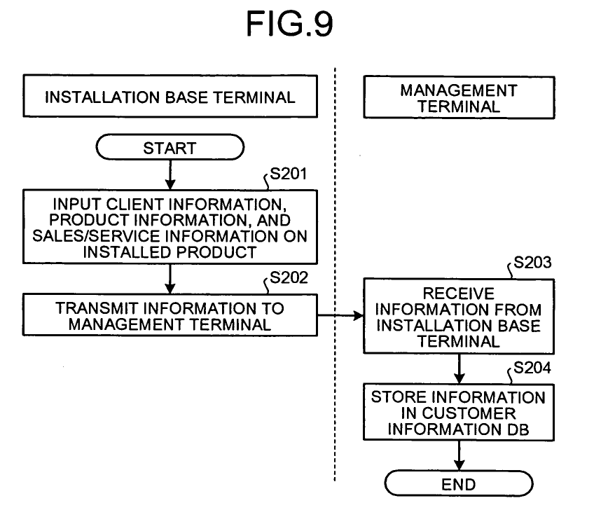

FIG. 9 is flowchart of a process performed at the installation base terminal 7 and the management terminal 1. At step S201, client (customer) information, product information, and sales/service information of the installed product 20 are input from the installation base terminal 7, for example, by a person in charge of the sales company.

A client code, a company name of the client, a location of the client, a department of the client, a person in charge of the client, and a mail address of the client are input as the client information. A category code (such as category number) and a product code (serial number or lot number) are input as the product information. However, the category code (such as category number) may be omitted.

A sales company code, a sales company name, a branch name of the sales company, a person in charge of the sales company, a service company code, a service company, a branch name of the service company, a person in charge of service company, an installation date to the client, an installation time to the client, and an estimated collection date after client finishes using the product are input as the sales/service information.

At step S202, the input information, i.e., data of the client (customer) information, the product information, and the sales/service information, is transmitted to the management terminal 1 via the network 15.

While at steps S201 and S202, an input template screen 200 is displayed on a display of the installation base terminal 7. On the input template screen 200, input fields 201, 202, and 203 to input the customer information, the sales/service information, and the recycling information are displayed. At the same time, under the input fields 201, 202, and 203, a selection button group 204 for selecting various conditions and scroll keys 205 and 206 are displayed. The scroll key 205 scrolls to the previous page or to the previous line, and the scroll key 206 scrolls to the next page or to the next line.

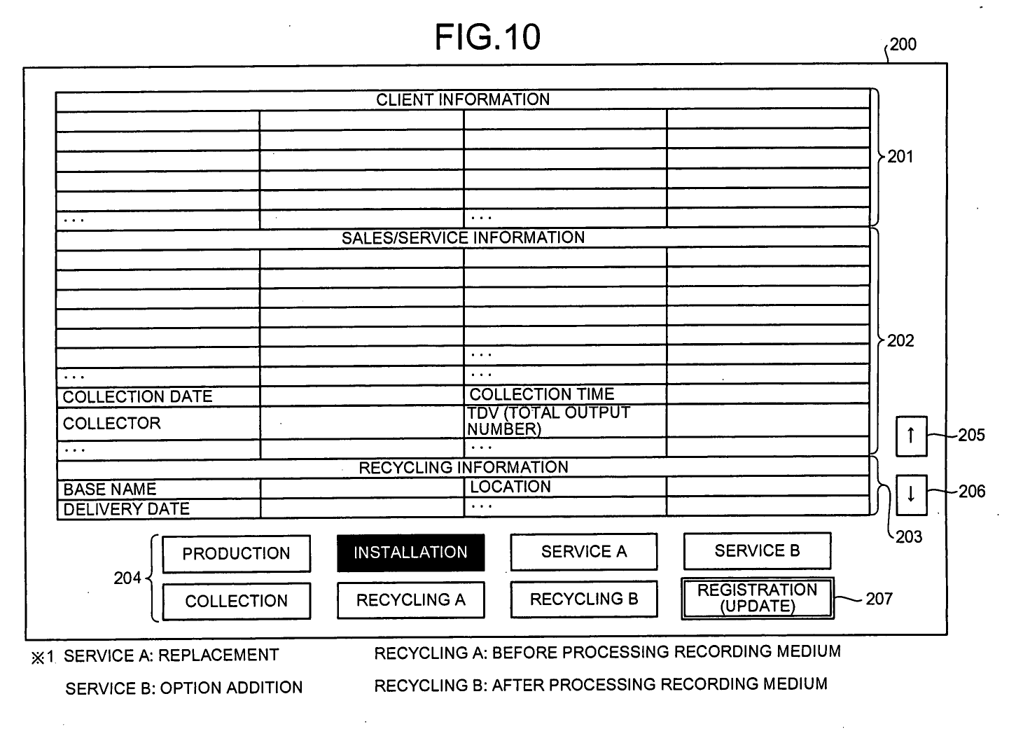

In the input template screen 200, when an operator selects and presses a button that corresponds to each step, for example, by using a mouse of the installation base terminal 7 or by operating keys, the pressed button is highlighted, and the input item is highlighted and displaying. Accordingly, the operator is prompted to input data for the input item displayed. The operator then inputs data and operates a registration button 207 of the selection button group 204, thereby completing the registration process and executing a transmission process for the management terminal 1. In FIG. 10, *1 explains the function of each button in the selection button group 204. A bar code reader, a portable information terminal such as a handheld computer, and the product 20 (for example, image forming apparatus) itself being used may be used as a terminal for the installation base terminal 7.

The process at steps S203 and S204 is performed at the side of the management terminal 1. At step S203, the product information is received from the installation base terminal 7. At step S204, the received product information is stored in the data table of the customer information DB 8b, and the process ends.

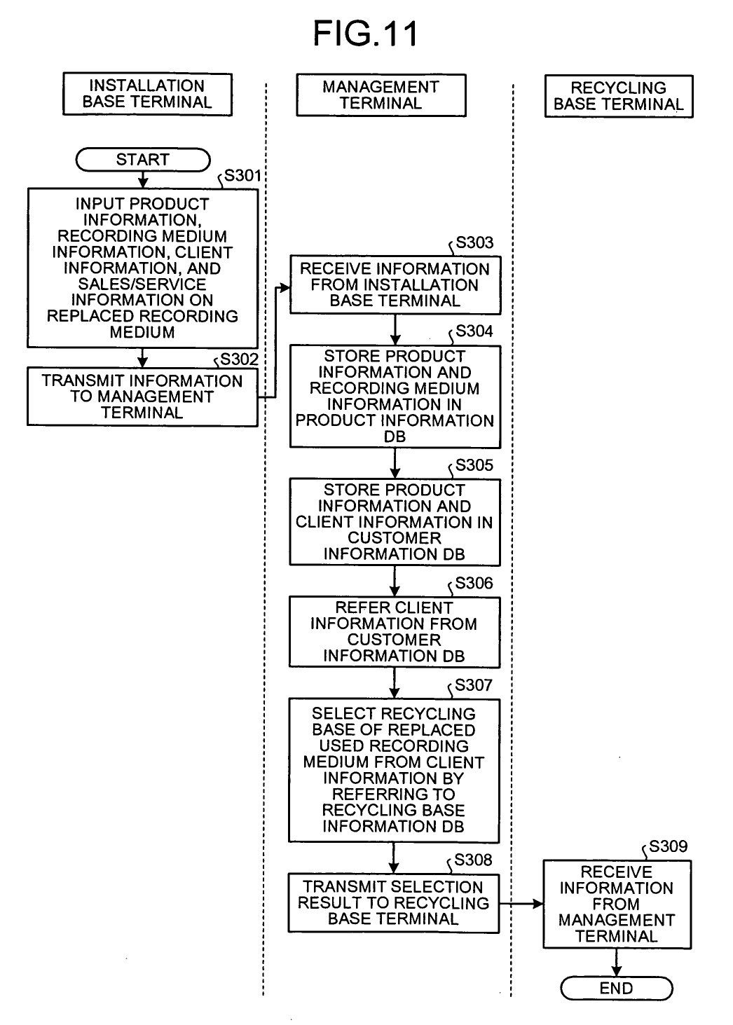

FIG. 11 is a flowchart of a process performed at the management terminal 1 and the recycling base terminal 6 when the state of the product 20 changes from the time of delivery, such as when the recording medium 21 is replaced in service or installed as an option. When the recording medium 21 is added as an option, the “recording medium detached from the product 20” is not obtained at the time of service replacement. Accordingly, the information related to the recording medium detached from the product 20 before being replaced is not required.

At step S301, the product information on the recording medium 21 installed anew on the product 20 by replacement, the recording medium information detached from the product 20, the client (customer) information, and the sales/service information are input from the installation base terminal 7 (business base terminal 3).

A product code (serial number or lot number) and a category code (such as category number) are input as the product information.

The number of the recording media 21, a category code (such as category number) of each recording medium before being replaced, a product code (serial number or lot number) of each recording medium before being replaced, the number of the recording media 21 after being replaced (added in option), a category code (such as category number) of each recording medium after being replaced (added in option), a product code (serial number or lot number) of each recording medium after being replaced (added in option), and the like are input as the recording medium information.

A client code, sales/service information, a sales company code, a service company code, a person in charge of the service company, date of visiting the client (service replacement date), and time of visiting the client (service replacement time) are input as the client information. When the sales company code and the service company code are already input at step S201, the input of the information may be omitted. At step S302, the input information is transmitted to the management terminal 1 via the network 15.

Among the information, the input of the category code (such as category number), the number of the recording media, the category code (such as category number) of each recording medium before being replaced, the product code (serial number or lot number) of each recording medium before being replaced, the sales company code, the service company code, the person in charge of the service company, and the like may be omitted. However, re-inputting these items makes it possible to match with the contents of the information that were input at first, thereby enabling to easily confirm unauthorized actions such as pilfering. As a result, the transportation management of the recording medium 21 can be carried out thoroughly.

The process at steps S303 through S308 is performed by the management terminal 1 at the time of service replacement or option addition. At step S303, various information is received from the installation base terminal 7 (business base terminal 3). At step S304, among the received information, the product information and the recording medium information are stored in the data table of the product information DB 8a. At step S305, the product information and the client information are stored in the data table of the customer information DB 8b. At step S306, the client information is referred from the customer information DB 8b. At step S307, a recycling base of the used recording medium 21A detached to be replaced is selected from the client information (for example, location of client) by referring to the recycling base information DB 8c. At step S308, the selection result is transmitted to the recycling base terminal 6 via the transmitting unit 11 and the network 15. At step S309, the recycling base terminal 6 receives the information from the transmitting unit 11 of the management terminal 1 via the network 15, and the process ends.

With such a configuration, the selecting unit 10 selects a recycling base, when the receiving unit 9 receives information from the installation base terminal 7 (business base terminal 3). As a result, the used product 20A and the used recording medium 21A installed thereon can be accurately and properly processed.

Information on parts and unit groups of the recording medium 21 and the like after being replaced the time of the service replacement, or information on parts and unit groups of the recording medium and the like added as an option are accurately reflected to the product information DB 8a. Accordingly, when a product ages, a certificate of the information processing result of a recording medium installed on the product can be provided to an ex-user (client) of the product and the like with higher reliability.

The information on the used recording medium 21A replaced and detached at the time of service can be delivered to the recycling base terminal 6 or the reproduction base terminal 5, before the recording medium 21A is delivered the recycling base or the reproduction base. Accordingly, a prior preparation, a planning, and the like for processing the recording medium 21A or for a processing certificate can be made in advance, at the recycling base terminal 6 or the reproduction base terminal 5. Moreover, a processing certificate of the recording medium 21A, which is described later, can be issued more speedily.

While picking up the used recording medium 21A, a recycling base or a reproduction base can be selected from the information of the used recording medium 21A. Therefore, the information on the recording medium 21A can be delivered to the recycling base terminal 6 or the reproduction base terminal 5, before the recording medium 21A is delivered to the recycling base or the reproduction base. Accordingly, unauthorized actions such as illegal dumping and illegal sale can be confirmed easily, thereby enabling to thoroughly carrying out the transportation management of the used recording medium 21A. Moreover, a processing certificate of the recording medium 21A can be issued with more certainty under high reliability.

Information management on portable recording media such as a flexible disk (FD) and a mini disk (MD), which is a magneto-optical memory apparatus, that are produced at the location of the client who is using the product 20 can also be carried out (by setting a new code that corresponds to the product code, such as equipment item number or serial number, for the recording media). Accordingly, a new service can be provided to the client and the convenience of the client can also be improved.

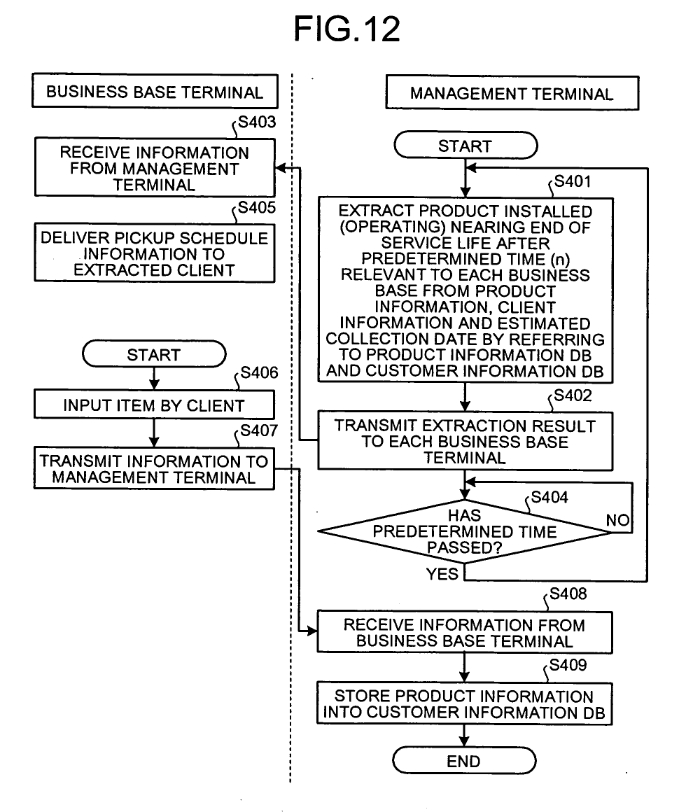

FIG. 12 is a flowchart of a process performed at the business base terminal 3 and the management terminal 1.

At step S401, in the management terminal 1, the extracting unit 12 extracts the customer information and the product information of the installed (operating) product (*2) that is supposed to end its service life after a predetermined time (n) relevant to each business base from the product information (for example, product code) and the client information (for example, client code) and estimated collection date by referring to the product information DB 8a and the customer information DB 8b. Incidentally, *2 may only indicate the product that the recording medium 21 is installed thereon.

At step S402, the transmitting unit 11 transmits the extraction result to each business base terminal 3 via the network 15. Then, the process control proceeds to step S404. At step S404, whether a predetermined time has passed is determined. If the predetermined time has passed, the process control returns to step S401. The predetermined time here refers to a period of extraction carried out at a predetermined unit, such as weekly or monthly, to periodically extract the product nearing the end of its service life.

The extraction result transmitted at step S402 is received by the business base terminal 3 at step S403. Then, at step S405, pickup schedule information containing information as described below (for example, client information card) is delivered to the client extracted.

The information that can be entered in the client information card includes a desired collection date A (item input by client) and an estimated collection date, the client information, the product information, and the recording medium information. Examples of the client information include a client code (may be omitted), a company name of the client, a location of the client, a department of the client, a person in charge of the client, and a mail address of the client. Examples of the product information include a category code (such as category number) and a product code (serial number or lot number). Examples of the recording medium information include whether the recording medium 21 is present (installed). If the recording medium 21 is present, the number of the recording media 21 and whether a processing (result) certificate of the recording medium 21 is desired may be checked (item input by client). If the processing certificate is desired, a processing method is selected.

Such pickup schedule information (for example, client information card) is sent to the client by fax or by post. When the client has the client terminal 4, the pickup schedule information is sent to the terminal 4. After the required items are entered or input, the pickup schedule information is collected by the business base or received by the business base terminal 3.

At step S406, an inputting process of the client information card is performed at the business base terminal 3. Specifically, items input (desired) by the client are input (assumed to be input by the person in charge of the sales company). The client information, such as the desired collection date A, whether the processing (result) certificate of the recording medium 21 is desired, a desired processing method of the recording medium 21, is input. When such information is input from the business base terminal 3, at step S407, the business base terminal 3 transmits the information on the client information card to the management terminal 1. In the management terminal 1, the receiving unit 9 receives the information from the business base terminal 3 at step S408 by. At step S409, the received information is stored in the customer information DB 8b, and the process ends.

As such, as shown in steps S402 and S403, the management terminal 1 notifies the business base terminal 3 a plurality of times at a predetermined time interval. Accordingly, the scheduled expiry date can be notified to the client without fail.

The client who uses the product 20 on which the recording medium 21 is not installed is not provided with the information related to the recording medium 21. Accordingly, unnecessary confusion, concern, and the like, for those clients using the product 20 can be prevented.

An ID and a password for confirmation and inquiry are issued, only when the client desires a processing (result) certificate of the recording medium 21. Accordingly, the number of the IDs and passwords can be reduced, thereby enabling to suppress unnecessary production of the IDs and the passwords.

In the business base terminal 3, whether a processing certificate of the recording medium 21 is desired, and the processing method can be confirmed to the client before collection (usage expiry date). Accordingly, it is possible to respond more accurately and speedily to the needs of the client who desires the recording medium 21 installed on the product 20 to be picked up (*3) and the recording medium 21 to be processed on-site (*4).

In the business base terminal 3, whether a processing certificate of the recording medium 21 is desired, and the processing method can be confirmed to the client before collection (usage expiry date). Accordingly, it is possible to make a prior preparation, a planning, and the like for the client who desires the recording medium 21 installed on the product 20 to be picked up (*3) and the recording medium 21 to be processed on-site (*4), efficiently in advance.

Incidentally, *3 indicates that the recording medium 21 such as HDD is detached from the product 20 in front of the client, handed to the client, and issuing a processing certificate if desired. Besides, *4 indicates that the recording medium 21 such as HDD is detached from the product 20 in front of the client, carrying out an information destroying process (such as flaw forming and physically damaging the recording medium 21) of the recording medium 21, and issuing a processing certificate if desired.

In the embodiment, the pickup schedule information delivered to the client can be a postcard; however, it is not limited to thereto, but can be transmitted to the client terminal 4.

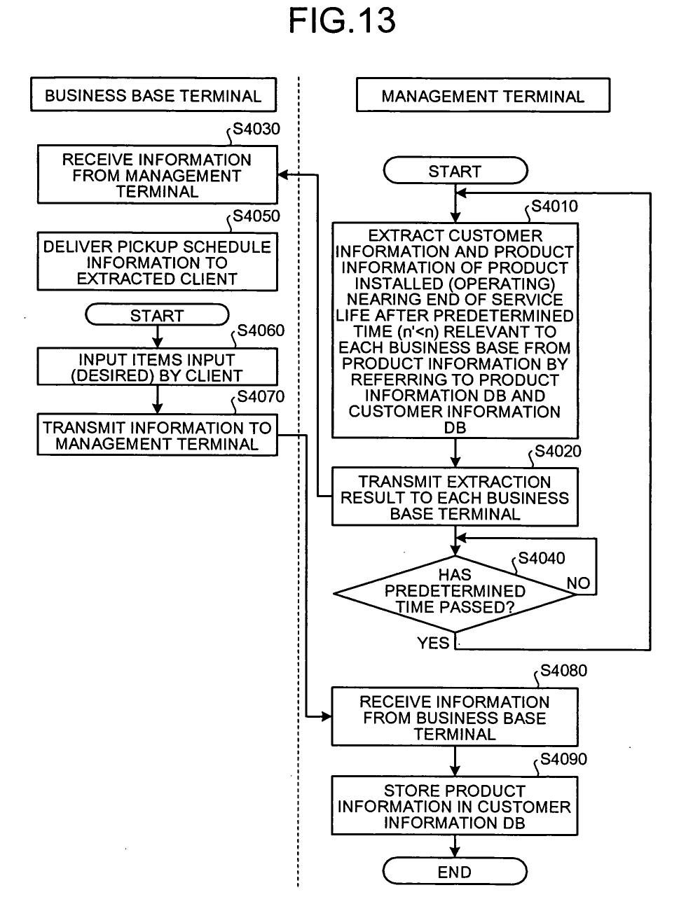

FIG. 13 is a flowchart of a process of delivering new pickup schedule information to a client who desires the processing (result) certificate of the recording medium in the process shown in FIG. 12. The main difference to the process of FIG. 12 is that a client's inquiry URL, a client's personal ID, and a client's personal password are issued as the other information. At step S4010, in the management terminal 1, among the installed (operating) products that is supposed to end its service life after a predetermined time (n′<n) relevant to each business base, the client information and the product information of the product 20 installed with the recording medium 21 are extracted from the product information (for example, product code and the recording medium is present) and the client information (for example, client code, estimated collection date, and a processing certificate of the recording medium is desired). This process is carried out by referring the product information DB 8a and the customer information DB 8b. The process shown in FIG. 13 is carried out after the process shown in FIG. 12.

At step S4020, the transmitting unit 11 transmits the extraction result to each business base terminal 3 via the network 15. At step S4040, whether a predetermined time has passed is determined. If the predetermined time has passed, the process control returns to step S4010. The predetermined time refers to a period of extraction carried out at a predetermined unit, such as weekly or monthly, to periodically extract the product nearing the end of its service life.

The extraction result transmitted at step S4020 is received by the business base terminal 3 at step S4030. Then, at step S4050, pickup schedule information containing information of the following example (for example, client information card) is delivered to the client extracted by the business base terminal 3.

The information that can be entered in the client information card includes, a desired collection date B (item input by client), which may be omitted when already input, an estimated collection date, the client information, the product information, the recording medium information, and the other information. Examples of the client information include a client code (may be omitted), a company name of the client, a location of the client, a department of the client, a person in charge of the client, and a mail address of the client may be included in the client information card. The desired collection date B is included because there may be a client who desires a date different from the desired collection date A entered earlier. Accordingly, the desired collection date A and the desired collection B are separated, so that the desired collection date can be input again at this point. Examples of the product information include a category code (such as category number) and a product code (serial number or lot number) may be included. Examples of the recording medium information include a category code (such as category number) and a product code (serial number or lot number) of the recording medium. Examples of the other information includes a client's confirmation (inquiry) URL, a client's personal ID, and a client's personal password.

Such pickup schedule information (for example, customer information card) is sent to the client by fax or by post. When the client has the client terminal 4, the pickup schedule information is sent to the terminal. After the required items are entered or input, the pickup schedule information is collected by the business base or received by the business base terminal 3.

At step S4060, an inputting process of the client information card is performed at the business base terminal 3. The items input (desired) by the client is input by a person in charge of the sales company. The client information, such as the desired collection date B, whether a processing (result) certificate of the recording medium 21 is required, the desired processing method of the recording medium 21, are input. Because whether the processing (result) certificate of the recording medium 21 is desired and the desired processing method of the recording medium 21 are already input at the previous step, they are omitted here, leaving only the desired collection date B. However, whether the processing (result) certificate of the recording medium 21 is desired, and the desired processing method of the recording medium 21 may be input again. This process is for the client who may not desire the processing (result) certificate at this point, even if he/she desired the processing (result) certificate earlier. Or, even when the processing (result) certificate is still desired, some customer may desire the different processing method from the previous answer. When such information is input from the business base terminal 3, at step S4070, the information on the client information card input from the business base terminal 3 is transmitted to the management terminal 1. In the management terminal 1, the receiving unit 9 receives the information from the business base terminal 3 at step S4080. At step 4090, the received information is stored in the customer information DB 8b, and the process ends.

When the processes described above in connection with FIGS. 12 and 13 are both carried out, the required information is already stored in the customer information DB 8b from the management terminal 1. If the client does not desire to change anything, there is no response from the client. In this case, the process from step S4060 to S4090 is not performed.

In this manner, as shown at steps S4020 and S4040, the management terminal 1 notifies the business base terminal 3 a plurality of times at a predetermined time interval. Accordingly, the scheduled expiry date can be notified to the client without fail.

Those clients using the product 20 not installed with the recording medium 21 is not provided with the information related to the recording medium 21. Accordingly, unnecessary confusion, concern, and the like, for those clients using the product 20 can be prevented.

Only when the client desires a processing (result) certificate of the recording medium 21, an ID and a password for confirmation and inquiry are issued. Accordingly, the number of IDs and passwords to be produced can be reduced, thereby enabling to suppress the unnecessary production of the IDs and the passwords.

In the business base terminal 3, whether a processing certificate of the recording medium 21 is desired, and the processing method can be confirmed to the client before collection (usage expiry date). Accordingly, it is possible to respond more accurately and speedily to the needs of the client who desires the recording medium 21 installed on the product 20 to be picked up (*3) and the recording medium 21 to be processed on-site (*4).

In the business base terminal 3, whether a processing certificate of the recording medium 21 is desired, and the processing method can be confirmed to the client before collection (usage expiry date). Accordingly, it is possible to make a prior preparation, a planning, and the like for the client who desires the recording medium 21 installed on the product 20 to be picked up (*3) and the recording medium 21 to be processed on-site (*4), efficiently in advance.

Incidentally, *3 indicates that the recording medium 21 such as HDD is detached from the product 20 in front of the client, handed to the client, and issuing a processing certificate if desired. Besides, *4 indicates that the recording medium 21 such as HDD is detached from the product 20 in front of the client, carrying out an information destroying process (such as flaw forming and physically damaging the recording medium 21) of the recording medium 21, and issuing a processing certificate if desired.

In the embodiment, the pickup schedule information is delivered to the client using a delivering unit such as a postcard. However, the delivering unit of the pickup schedule information is not limited to the present method, but a method of transmitting the pickup schedule information to the client terminal 4 and the like may be selected.

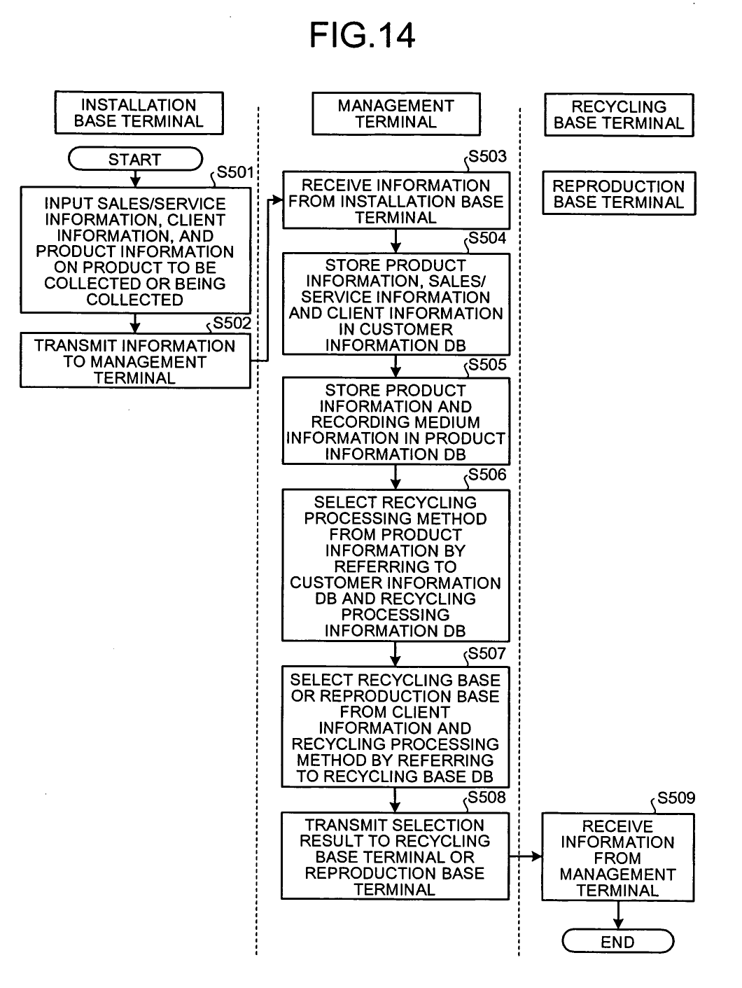

FIG. 14 is a flowchart of a process performed at the installation base terminal 7, the management terminal 1, the reproduction base terminal 5, and the recycling base terminal 6. The process at steps S501 and S502 is performed at the installation base terminal 7. At step S501, sales/service information, client (customer) information, product information, and recording medium information related to the products 20 and 20A to be collected or being collected are input. The sales/service information includes a collection date, a collection time, a collector, and a TDV. The client information includes a client code. The product information includes a category code (such as category number), which may be omitted, and a product code (serial number or lot number). The recording medium information includes a processing result (*5) of the recording medium at the time of collection. The processing result of the recording medium at the time of collection may not be the recording medium information, but may be the sales/service information. Incidentally, *5 indicates a delivery to the client, processing on the site, pick up of each product, and the like. At step S502, the data input from the installation base terminal 7 is transmitted to the management terminal 1 via the network 15.

The process at steps S503 to S308 is performed at the management terminal 1. At step S503, various types of information is received from the installation base terminal 7. At step S504, among the received information, the product information and sales/service information and client information are stored in the customer information DB 8b. At step S505, the product information and recording medium information are stored in the product information DB 8a.

At step S506, a recycling method (such as processed to be recycled and utilized as reproduction equipment) is selected from the product information (category code and product code) and the sales/service information (TDV) referring to the customer information DB 8b and the recycling processing information DB 8d. At step S507, a recycling base or a reproduction base is selected from the client information (for example, location of client) and the recycling method referring to the recycling base information DB 8c. At step S508, the transmitting unit 1 transmits the selection result to the reproduction base terminal 5 or the recycling base terminal 6 via the network 15. At step S509, the reproduction base terminal 5 or the recycling base terminal 6 receives the selection result from the transmitting unit 11 of the management terminal 1 via the network 15, and the process ends. At step S506, the TDV is used to select the recycling method. However, the usage of the used product 20A may be determined based on the standard.

By carrying out such a process, the information on the used product 20A can be delivered to the reproduction base terminal 5 or the recycling base terminal 6, before the used product 20A is delivered to the recycling base or the reproduction base. Therefore, at the recycling base or the reproduction base, it is possible to prepare and plan for disassembling and separating, recycling, reproduction, and the like of the used product 20A, particularly, preparation planning, and the like for processing the used recording medium 21A and for the processing certificate in advance. Moreover, a processing certificate of the recording medium 21A can be issued more speedily.

In picking up the used product, a recycling base or a reproduction base can be selected from the information of the used product 20A. Moreover, the information on the used product can be delivered to the recycling base terminal 6 or the reproduction base terminal 5, before the used product 20A is delivered to the recycling base or the reproduction base. Accordingly, unauthorized actions such as illegal dumping, illegal sale, pilfering of parts and unit groups of the recording medium, and the like can be easily confirmed. As a result, the transportation management of the used product 20 can be carried out thoroughly. Further, a processing certificate of the recording medium 21A can be issued with more certainty under high reliability.

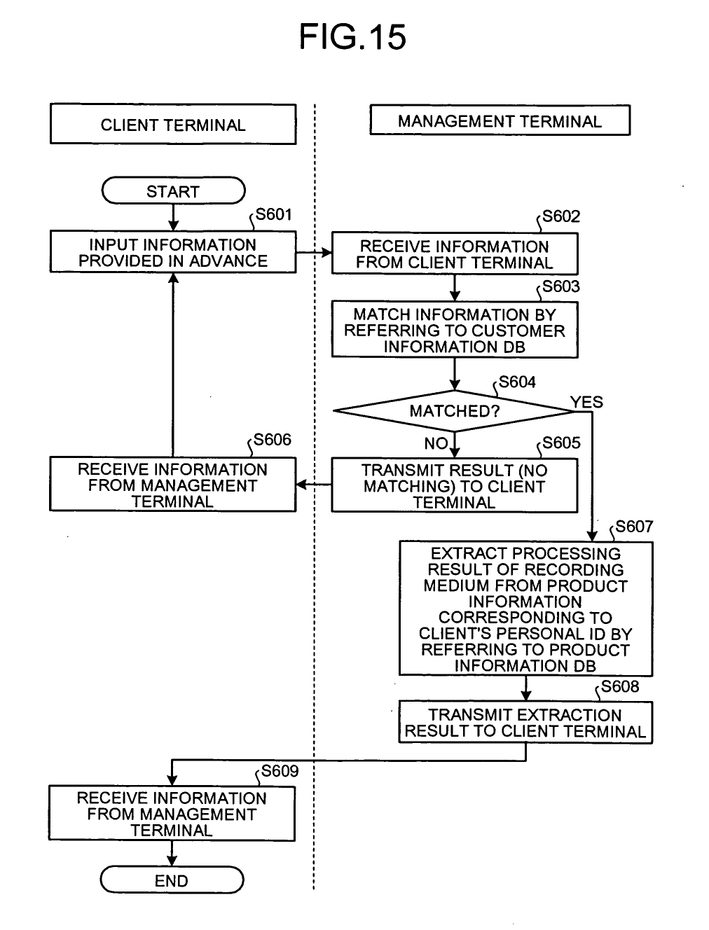

FIG. 15 is a flowchart of a process performed at the client terminal 4 and the management terminal 1. At step S601, a client's confirmation (inquiry) URL, a client's personal ID, a client's personal password, and the like, which are provided in advance, are input from the client terminal 4, and transmitted to the management terminal 1 via the network 15. At step S602, the receiving unit 9 receives the information input from the client terminal 4 via the network 15 and. Then, at step S603, the received information is verified by referring to the customer information DB 8b. At step S604, the verification result is determined. If the information is verified, the process control proceeds to step S607. If not, the process control proceeds to step S605. At step S605, the transmitting unit 11 transmits the verification result (no matching) to the client terminal 4 via the network 15. At step S606, the transmitted verification result is received by the client terminal 4. After that, the process control returns to step S601, and prompt the user to input the client's confirmation (inquiry) URL, the client's personal ID, and the client's personal password again to the client terminal 4.

At step S607, the processing result of the recording medium 21 is extracted from the product information (for example, product code) that corresponds to the client's personal ID referring to the product information DB 8a. Then, the process control proceeds to step S608. The processing result may include, for example: “complete delivery to the client”, “complete on-site processing”, “unprocessed”, “estimated to be processed by so-and-so method”, and “complete process by so-and-so method”.

At step S608, the transmitting unit 11 transmits the extraction result to the client terminal 4 via the network 15. At step S609, the transmitted extraction result is received by the client terminal 4, and the process ends.

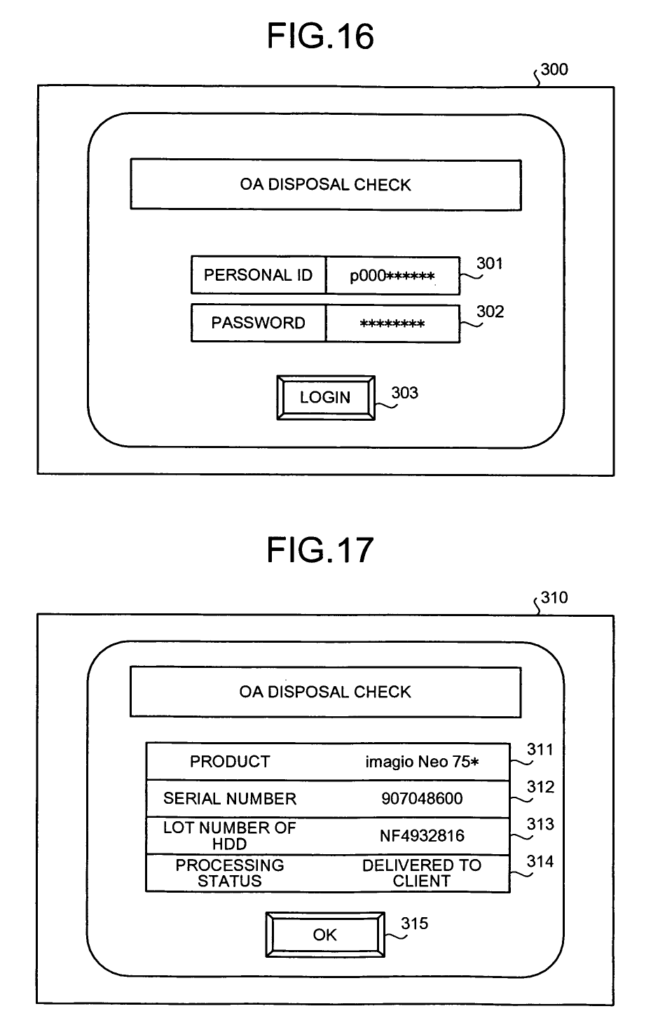

FIG. 16 is a schematic diagram of a login screen 300 displayed on a display of the client terminal 4 at step S601 in FIG. 15. On the login screen 300, input fields 301 and 302 for the client's personal ID and the password, and a login button 303 for transmitting the information are displayed. The input information is transmitted to the management terminal 1, when an operator of the client terminal 4 operates the login button 303.

FIG. 17 is a schematic diagram of a confirmation screen 310 displayed on the display of the client terminal 4 at step S609 in FIG. 15. On the confirmation screen 310, display fields 311 through 314 that display a product name, an equipment item number, a lot number of the recording medium 21 (HDD), and a processing status are displayed. An “OK” button 315 that closes the screen by pressing after confirming the display contents is also displayed thereon. At the client terminal 4, the status of the used product 20A and the used recording medium 21A can be confirmed in real time, by confirming the screen.

In the process shown in FIG. 15, the status of the used product 20A and the used recording medium 21A is confirmed, by accessing to the management terminal 1 from the client terminal 4. However, the status of the used product 20A and the used recording medium 21A can be confirmed in real time, by accessing to the management terminal 1 from the business base terminal 3 or the installation base terminal 7. The business base terminal 3 and the client terminal 4 include information communication equipments such as a computer and a mobile phone that include information communication and information processing functions. Particularly, at the business base, making accessible to the management terminal 1 from a mobile terminal makes it possible to correspond speedily to the inquiry from the client, while doing business elsewhere.

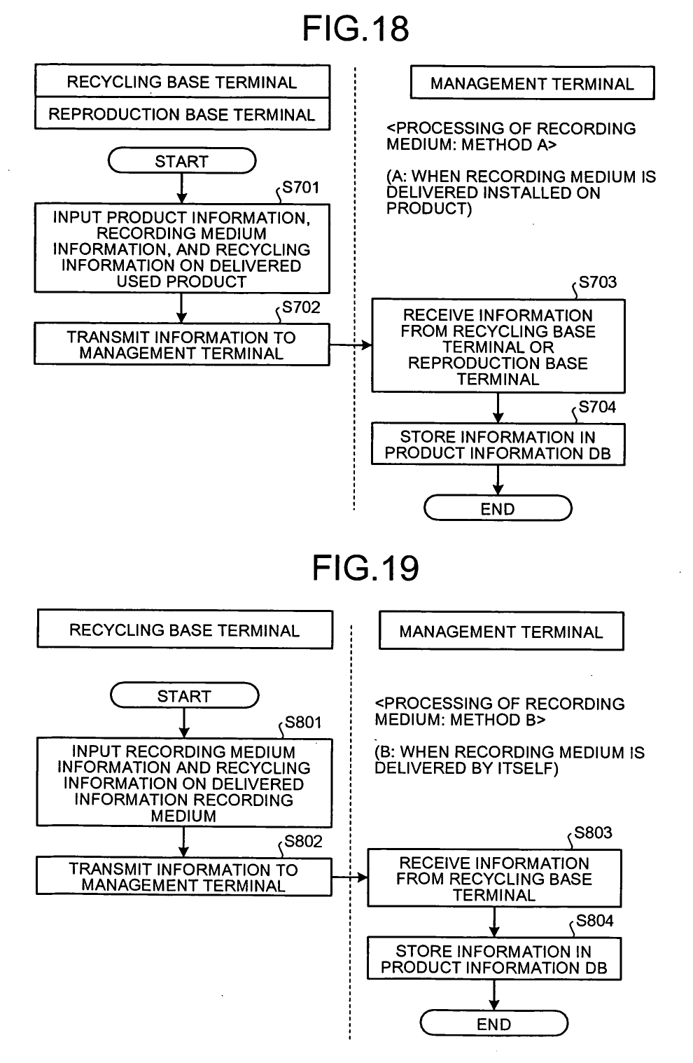

FIG. 18 is a flowchart of a process performed at the reproduction base terminal 5, the recycling base terminal 6, and the management terminal 1. In the process of FIG. 18, a method A is used for processing the recording medium. The method A is used when the recording medium 21A is delivered as being installed on the used product 20A.

In the reproduction base terminal 5 or the recycling base terminal 6, at step S701, the product information, the recording medium information, and the recycling information related to the used product 20A delivered are input.

A category code (such as category number), which can be omitted, and a product code (serial number or lot number) are input as the product information. The number of the recording media 21A, a category code (such as category number) of each recording medium, which can be omitted, and a product code (serial number or lot number) of each recording medium, which can be omitted, are input as the recording medium information. A recycling/reproduction base name, a location of the recycling/reproduction base, a delivery date to the recycling/reproduction base, a processing start date of the used product, a person in charge of processing the used product, a processing method of each recording medium, a processing start date of each recording medium, a person in charge of processing each recording medium, and a material (such as photograph) for each recording medium before being processed are input as the recycling information.

At step S702, the information input at step S701 is transmitted to the management terminal 1 via the network 15. At step S703, the receiving unit 9 receives the information transmitted from the reproduction base terminal 5 or the recycling base terminal 6 via the network 15. At step S704, the received information is stored in the product information DB 8a, thereby finishing the process.

At the reproduction base, a reproduction preparation such as disassembling and separating, cleaning, assembling, and the like of the used product 20A that includes the recording medium 21A being delivered is carried out. Moreover, a process of erasing information of the recording medium 21A, a preparation of issuing a processing certificate of the processed recording medium 21A, and the like are carried out.

At the recycling base, disassembling and separating, and preparation for a recycling process of the used product 20A that includes the recording medium 21A being delivered are carried out. Moreover, a process of erasing information of the recording medium 21A and a preparation of issuing a processing certificate of the processed recording medium 21A and the like are carried out.

FIG. 19 is a flowchart of a process performed at the recycling base terminal 6 and the management terminal 1. In the process of FIG. 19, a method B is used for processing the recording medium. The method B is used when the recording medium 21A is delivered by itself.

In the recycling base terminal 6, at step S801, the recording medium information and the recycling information related to the recording medium 21A delivered are input. A category code (such as category number) of each recording medium, which can be omitted, and a product code (serial number or lot number) of each recording medium are input and processed as the recording medium information. A recycling/reproduction base name, a location of the recycling/reproduction base, a delivery date to the recycling/reproduction base, a method of processing each recording medium, a processing start date of each recording medium, a person in charge of processing each recording medium, and a material (such as photograph) for each recording medium before being processed are input as the recycling information.

At step S802, the information input at step S801 is transmitted to the management terminal 1 via the network 15. At step S803, the receiving unit 9 receives the information from the recycling base terminal 6 via the network 15. At step S804, the received information is stored in the product information DB 8a, and the process ends.

In this manner, when the information is input from the recycling base terminal 6, the process of erasing the information of the recording medium 21A delivered, the preparation of issuing the processing certificate of the processed recording medium 21A, and the like can be carried out at the recycling base.

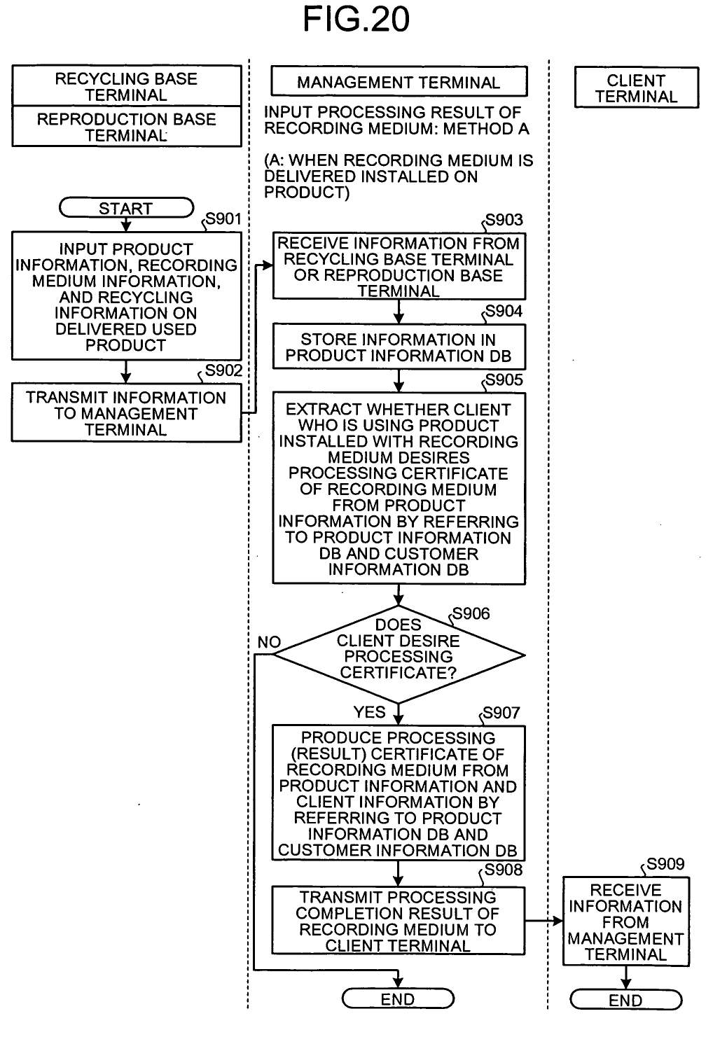

FIG. 20 is a flowchart of a process performed at the reproduction base terminal 5, the recycling base terminal 6, the management terminal 1, and the installation base terminal 7. In the process of FIG. 20, a method A is used for inputting the processing result of the recording medium. The method A is used when the recording medium 21A is delivered at a state installed on the used product 20A.

In the reproduction base terminal 5 or the recycling base terminal 6, at step S901, the product information, the recording medium information, and the recycling information related to the used product 20 delivered are input. A category code (such as category number), which can be omitted, and a product code (serial number or lot number) are input as the product information. A category code (such as category number) of the recording medium, which can be omitted, and a product code (serial number or lot number) of the recording medium, which can be omitted, are input as the recording medium information. A processing completion (conducted) date of the recording medium, a processing result of the recording medium, a material (such as photograph) for the processing certificate of the recording medium, a processing completion date of the used product, and the usage of the used product (such as reused as a product and material recycled) are input as the recycling information.

At step S902, the information input at step S901 is transmitted to the management terminal 1 via the network 15. At step S903, the receiving unit 9 receives the information transmitted from the reproduction base terminal 5 or the recycling base terminal 6 via the network 15. At step S904, the received information is stored in the product information DB 8a.

At step S905, whether the client who is using the product 20A installed with the recording medium 21A desires a processing certificate of the recording medium, is extracted from the product information (for example, product code and product code of the processed recording medium) and the client information (for example, client code). This process is carried out by referring to the product information DB 8a and the customer information DB 8b. Then, the process control proceeds to step S906.

At step S906, whether the client desires the processing certificate is determined. If the client does not desire the processing certificate, the process ends. If the client desires the processing certificate, the process control proceeds to step S907. At step S907, the processing (result) certificate of the recording medium 21A is produced from the product information (for example, product code of the processed recording medium) and the client information (for example, client code) referring to the product information DB 8a and the customer information DB 8b.

The following items, for example, may be entered in the processing (result) certificate of the recording medium:

### Client Information

Client code, company name of client, location of client, department name of client, person in charge of client, mail address of client

### Product Information

Category code (such as category number), product code (serial number or lot number)

### Recording Medium Information

Whether recording medium is present (installed). When present, the number of recording media, category code (such as category number) of each recording medium, product code (serial number or lot number) of each recording medium

### Recycling Information

Name of recycling/reproduction base, processing method of recording medium, processing completion (conducted) date of recording medium

### Processing Result of Recording Medium

Material (such as photograph) for a processing certificate of recording medium, processing completion date of used product, usage of used product (such as reused as product and material recycled)

At least one of a set of a product code (such as equipment item number) of the used product 20A and a product code (such as category number) of the processed recording medium 21A, and a product code (such as lot number) may preferably be stored (recorded or filmed) as a material for the processing certificate of the recording medium 21A at this time. This is because the recording medium 21A can be proved to be the recording medium installed on the used product 20A with more certainty. At step S908, the processing completion result of the recording medium 21A is transmitted to the installation base terminal 7, and the process ends.

Particularly at step S901, the material for the processing certificate can be searched more speedily by using the specific code (such as equipment item number or serial number) of the recording medium 21 or the product 20 installed with the recording medium 21, as a management name (such as file name) of the material for the processing certificate of the recording medium 21A. The material for the processing certificate of the recording medium 21A at step S901 may be prepared only when the client desires the processing certificate.

By issuing the processing certificate only to the client who desires the processing certificate of the recording medium 21A, issuing of unnecessary processing certificate can be prevented. Moreover, the issued certificates can be managed efficiently, and the load of the issuing business of the recording medium processing certificate can also be reduced.

On completion of the processing of the recording medium 21A, the client can be notified of the processing result of the recording medium 21A from the installation base, if the installation base transmits the processing completion result to the client terminal 4 for the client who desires the processing certificate. Even if the client forgets that he/she desired the processing certificate of the recording medium 21A, by transmitting the processing completion result to the client terminal 4, the business base terminal 3, or the installation base terminal 7 on completion of the processing of the recording medium 21A, the client can be reliably notified of the processing result of the recording medium 21A.

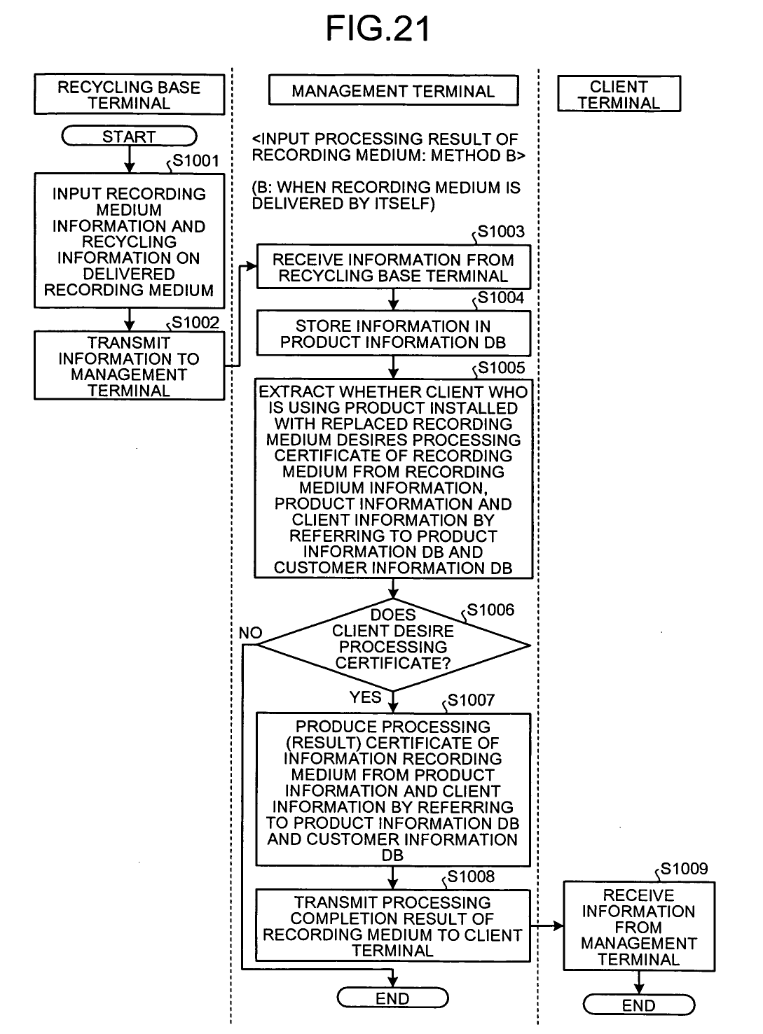

FIG. 21 is a flowchart of a process performed at the recycling base terminal 6, the management terminal 1, and the client terminal 4. In the process of FIG. 21, a method B is used for inputting the processing result of the recording medium. The method B is used when the recording medium 21A is delivered by itself.

In the recycling base terminal 6, at step S1001, the recording medium information and the recycling information related to the recording medium 21A delivered is input. A category code (such as category number) of the recording medium, which can be omitted, and a product code (serial number or lot number) of the recording medium are input as the recording medium information. A processing completion (conducted) date of the recording medium, the processing result of the recording medium, and the material (such as photograph) for the processing certificate of the recording medium are input as the recycling information.

At step S1002, the information input at step S1001 is transmitted to the management terminal 1 via the network 15. At step S1003, the receiving unit 9 receives the information transmitted from the recycling base terminal 6 via the network 15. At step S1004, the received information is stored in the product information DB 8a.

At step S1005, whether a client who is using the product 20A installed with the replaced recording medium 21A desires a processing certificate of the recording medium 21A is extracted from the recording medium information (for example, the product code of the processed recording medium), product information (for example, product code), and the client information (for example, client code) referring to the product information DB 8a and the customer information DB 8b. Then, the process control proceeds to step S1006.

At step S1006, whether the client desires a processing certificate is determined. If the client does not desire the processing certificate, the process ends. If the client desires the processing certificate, the process control proceeds to step S1007. The processing (result) certificate of the recording medium 21A is produced from the product information (for example, product code of the processed recording medium) and the client information (for example, client code) referring to the product information DB 8a and the customer information DB 8b.

The following items, for example, may be entered in the processing (result) certificate of the recording medium 21A:

### Customer Information

Client code, company name of client, location of client, department name of client, person in charge of client, mail address of client

### Product Information

Category code (such as category number), product code (serial number or lot number)

### Recording Medium Information

Whether recording medium is present (installed). When present, the number of recording media, category code (such as category number) of each recording medium, product code (serial number or lot number) of each recording medium

### Recycling Information

Recycling/reproduction base name, processing method of recording medium, processing completion (conducted) date of recording medium

### Processing Result of Recording Medium

Material (such as photograph) for a processing certificate of recording medium, processing completion date of used product, usage of used product (such as reused as product and material recycled)

At least one of a set of a product code (such as equipment item number or serial number) of the used product 20A and a product code (such as category number) of the processed recording medium 21A, and a product code (such as lot number) may preferably be stored (recorded or filmed) as the material for the processing certificate of the recording medium 21A at this time. This is because the recording medium 21A can be proved to be the recording medium installed on the used product 20A with more certainty.

At step S1008, the processing completion result of the recording medium 21A is transmitted to the installation base terminal 7, and the process ends.

Particularly, at step S1001, the material for the processing certificate can be searched more speedily, by using the specific code (such as equipment item number) of the recording medium 21 or the product 20 installed with the recording medium, as a management name (such as file name) of the material for the processing certificate of the recording medium 21A. The material for the processing certificate of the recording medium 21A at step S1001 may be prepared only when the client desires the processing certificate.

By issuing the processing certificate only to the client who desires the processing certificate of the recording medium 21A, issuing of unnecessary processing certificate can be prevented. Moreover, the issued certificates can be managed efficiently and the load of the issuing business of the recording medium processing certificate can also be reduced.

On completion of the processing of the recording medium 21A, the processing result of the recording medium can be notified to the client from the management terminal 1, by transmitting the processing completion result to the installation base terminal 7 that corresponds to the client, for the client who desires the processing certificate. Even if the client forgets that he/she desired the processing certificate of the recording medium, by transmitting the processing completion result to the installation base terminal 7 on completion of the processing of the recording medium, the client can be reliably notified of the processing result of the recording medium 21A.

Particularly, to the client terminal, by inputting a mail address in advance as client information, on completion of the processing of the recording medium 21A, the processing completion result can be transmitted to the client terminal, for the client who desires the processing certificate. This process can save the client from confirming the processing result of the recording medium from the client terminal 4 repeatedly, thereby improving the convenience of the client.

In the processes shown in FIGS. 20 and 21, the processing completion result of the recording medium 21A is delivered to the client by transmitting from the management terminal 1 to the client terminal 4. However, the processing completion result of the recording medium 21A can be transmitted to the business base terminal 3 or the installation base terminal 7 from the management terminal 1. The transmitting mode of the processing completion result of the recording medium 21A is not limited to the transmission via the network 15, but a transmitting unit such as postcard may also be used.

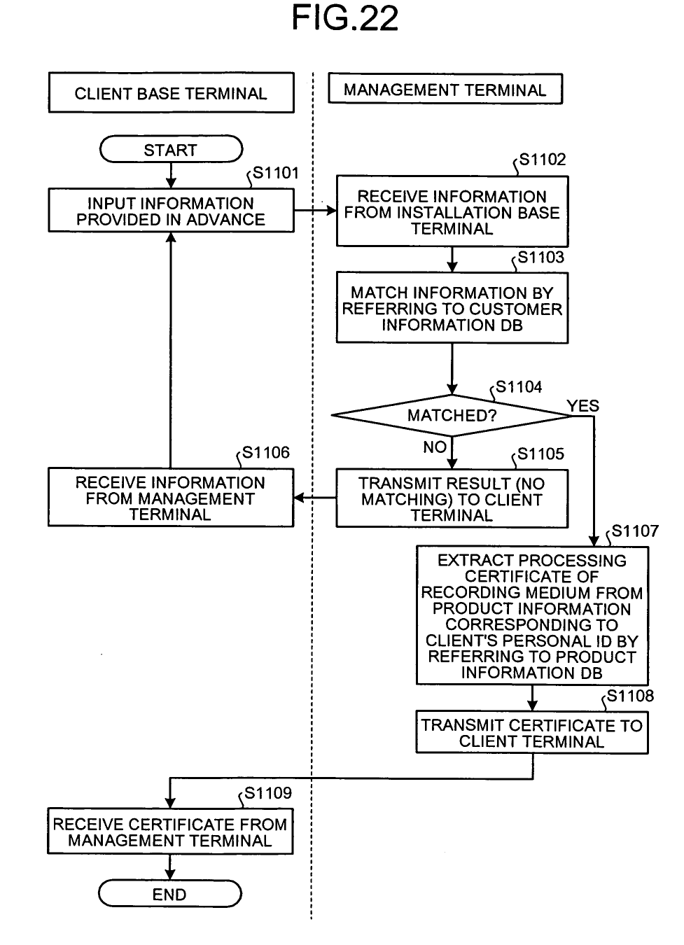

FIG. 22 is a flowchart of a process performed at the client terminal 4 and the management terminal 1. At step S1101, the client's confirmation (inquiry) URL, the client's personal ID, the client's personal password, and the like provided in advance are input from the client terminal 4 and transmitted to the management terminal 1. At step S1102, the receiving unit 9 receives the input information via the network 15. Then, the process control proceeds to step S1103. At step S1103, the management terminal 1 verifies the information received by referring to the customer information DB 8b. At step S1104, the verification result is determined. If the information is verified, the process control proceeds to step S1107. If the information is not verified, the process control proceeds to step S1105. At step S1105, the transmitting unit 11 transmits the verification result (no matching) to the client terminal 4 via the network 15. At step S1106, the transmitted verification result is received by the client terminal 4. After that, the process control returns to step S1101, to prompt the user to input the client's confirmation (inquiry) URL, the client's personal ID, and the client's personal password again.

At step S1107, the processing certificate of the recording medium 21 is extracted from the product information (for example, product code) that corresponds to the client's personal ID referring to the product information DB 8a. Then, the process control proceeds to step S1108. At step S1108, the transmitting unit 11 transmits the extracted processing certificate to the client terminal 4 via the network 15. At step S1109, the transmitted processing certificate is received by the client terminal 4, and the process ends.

In this manner, the authentication information is input from the client terminal 4. If authenticated, the processing certificate of the recording medium 21 that corresponds to the authenticated client information is transmitted to the authenticated client terminal 4. Accordingly, the processing certificate of the recording medium 21 can be obtained in real time. Particularly, to the client terminal 4, the processing certificate can be transmitted to the requested client terminal 4 by inputting the mail address in advance as client information. This process can save the client from confirming the processing certificate of the recording medium from the client terminal 4 repeatedly, thereby improving the convenience of the client.

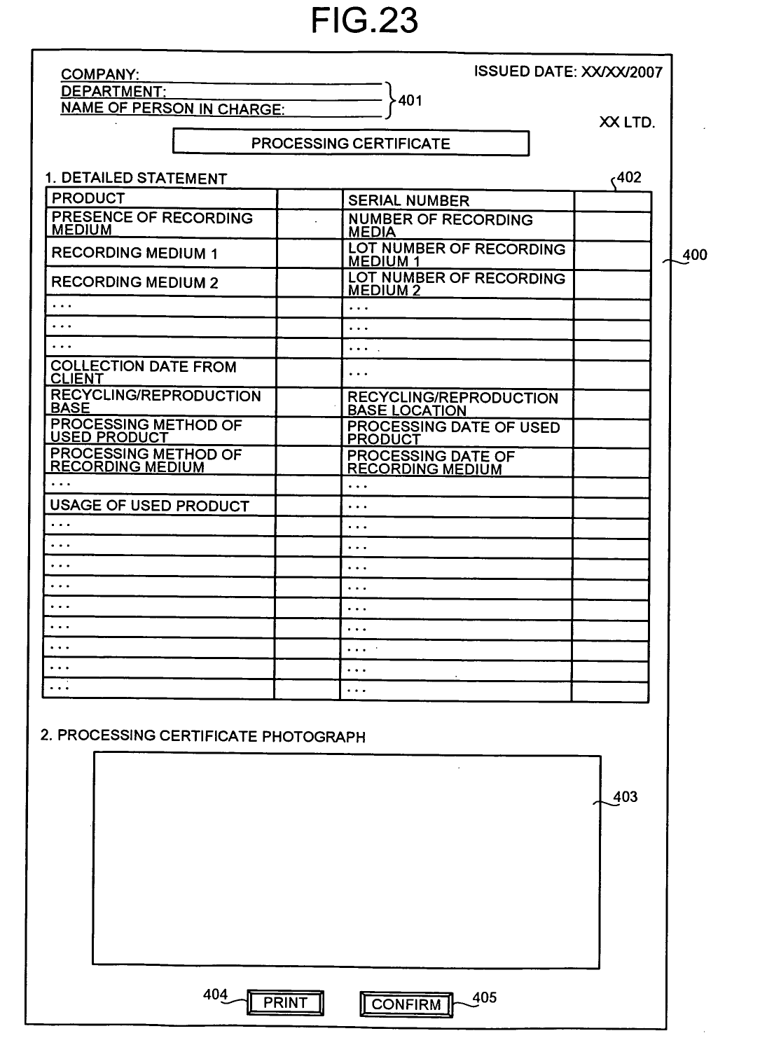

FIG. 23 is a schematic diagram of a notification screen 400 displayed on the display of the client terminal 4 at step S1109 in FIG. 22. On the notification screen 400 are displayed a client display field 401 in which a name and a department of the client who has requested, a name of a person in charge, and the like are displayed, a specification column 402 in which various types of information related to the processed product are entered, a field 403 in which a processing certificate photograph is displayed, a print button 404 for printing instruction, and a confirmation button 405 for confirming the contents of the notification. In the client terminal 4, when the operator only carries out the confirmation in response to the request of the client, the screen is closed by operating the confirmation button 405 after browsing the notification screen 400. If the printing is requested, the operator operates the print button 404. In this case, the processing certificate can be printed, by connecting a printing apparatus, which is not shown, to the client terminal 4 by a printer cable or a LAN cable.

In the process shown in FIG. 22, the processing certificate of the recording medium 21A is delivered to the client, by transmitting from the management terminal 1 to the client terminal 4. However, the processing certificate of the recording medium 21A can be transmitted from the management terminal 1 to the business base terminal 3 or the installation base terminal 7. By doing so, even when the client requests the business base and the installation base to issue the processing certificate, immediate response can be made. The transmitting mode of the processing certificate of the recording medium 21A is not limited to the transmission via the network 15, but the transmitting unit such as a postcard may be used.

With such a configuration, the issuing of the processing certificate of the recording medium 21A installed on the collected product 20A can be carried out more speedily and accurately with high reliability. Moreover, the load of the issuing business of the processing certificate of the recording medium 21A can be reduced considerably. Because the system is made of the management terminal 1 and each base terminal connected to the network 15, a penetration rate is high. Moreover, the information on the product other than the company's own product can be managed. For example, when an OEM business such as manufacturing a product sold under the other company's brand, and supplying product from the other company and selling the product under the own brand is to be conducted, the terminal can be installed for the OEM product, as the own product, and the information of the product can be managed by inputting required items.

As set forth hereinabove, according to an embodiment of the present invention, a product installed with a new recording medium as well as a used product and a recording medium installed thereon can be processed reliably and properly. In addition, at the recycling base and the reproduction base, preparation and planning for recycling, reproduction, and the like of a product and a recording medium detached from the product can be made in advance.

Moreover, unauthorized actions such as illegal dumping, illegal sale, and pilfering of parts and unit groups of a recording medium and the like can be detected easily. As a result, transportation of used products can be managed thoroughly.

Furthermore, an ex-user or the like of a product can be reliability notified of the processing result of a recording medium installed on the product. On the other hand, information on a recording medium is not provided to a customer who is using a product not installed with the recording medium. Thus, unnecessary confusion for the customer can be prevented. Besides, unnecessary IDs and passwords can be prevented from being created, and the management load can be reduced.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information management system comprising:
a management terminal; and
at least one terminal that is connected to the management terminal via a network, wherein
the terminal includes
a first terminal that receives at least product information on a product and recording medium information;
a second terminal that receives at least customer information on a customer using the product;
a recycling base terminal that receives at least recycling information on recycling of at least one of a used product and a recording medium attached to the used product; and
a reproduction base terminal that receives at least reproduction information on reproduction of at least one of a used product and a recording medium attached to the used product,
the management terminal includes
a first receiving unit that receives the product information and the recording medium information from the first terminal;
a first storage unit that stores therein information received by the first receiving unit;
a second receiving unit that receives the customer information from the second terminal;
a second storage unit that stores therein information received by the second receiving unit;
a selecting unit that selects, when the second receiving unit receives information from the second terminal, any one of the recycling base terminal and the reproduction base terminal as a selection terminal based on the information stored in the first storage unit; and
a transmitting unit that transmits at least one of the product information and the recording medium information to the selection terminal.

2. The information management system according to claim 1, wherein the selecting unit selects the selection terminal when the second receiving unit receives used-product information on a used product from the second terminal.

3. The information management system according to claim 2, wherein the management terminal transmits the used-product information to the selection terminal before the used product arrives at the selection terminal.

4. The information management system according to claim 1, wherein the selecting unit selects the recycling base terminal when the second receiving unit receives detached-medium information on a recording medium detached from a product.

5. The information management system according to claim 4, wherein the management terminal transmits the detached-medium information to the selection terminal before the recording medium detached from the product arrives at the selection terminal.

6. The information management system according to claim 1, wherein the selecting unit selects the selection terminal when the second receiving unit receives information on at least one of a replacement recording medium attached to a product to replace an old recording medium and an additional recording medium additionally attached to the product.

7. The information management system according to claim 6, wherein the selecting unit selects the selection terminal when the second receiving unit receives information that the product attached with at least one of the replacement recording medium and the additional recording medium reaches end of service life.

8. The information management system according to claim 1, wherein at least one of the first storage unit and the second storage unit is capable of storing therein information on a plurality of recording media attached to a product.

9. The information management system according to claim 1, wherein
the management terminal includes an extracting unit that extracts information on a product that reaches end of service life after elapse of a predetermined time based on the product information and the customer information stored in the first storage unit and the second storage unit, and
the extracting unit extracts different information depending on whether a recording medium is attached to the product.

10. The information management system according to claim 1, wherein
the management terminal includes an extracting unit that extracts information on a product that reaches end of service life after elapse of a predetermined time based on the product information and the customer information stored in the first storage unit and the second storage unit, and
the extracting unit extracts different information depending on whether a recording medium processing certificate is required.

11. The information management system according to claim 9, wherein the management terminal repeatedly transmits the information extracted by the extracting unit to the second terminal at a predetermined time interval.

12. The information management system according to claim 1, wherein the management terminal includes a creating unit that creates a recording medium processing certificate based on the product information, the recording medium information, and the customer information stored in the first storage unit and the second storage unit.

13. The information management system according to claim 12, wherein the creating unit creates the recording medium processing certificate when the recording medium processing certificate is required.

14. The information management system according to claim 12, wherein the management terminal includes a notifying unit that notifies at least the second terminal of completion of processing a recording medium when the recording medium processing certificate is required.

15. An information management method applied to an information management system including a management terminal and at least one terminal that is connected to the management terminal via a network, the terminal including a first terminal that receives at least product information on a product and recording medium information, a second terminal that receives at least customer information on a customer using the product, a recycling base terminal that receives at least recycling information on recycling of at least one of a used product and a recording medium attached to the used product, and a reproduction base terminal that receives at least reproduction information on reproduction of at least one of a used product and a recording medium attached to the used product, the information management method comprising, in the management terminal:
first receiving the product information and the recording medium information from the first terminal;
first storing information received at the first receiving;
second receiving the customer information from the second terminal;
second storing information received at the second receiving;
selecting, when information is received from the second terminal at the second receiving, any one of the recycling base terminal and the reproduction base terminal as a selection terminal based on the information stored at the first storing; and
transmitting at least one of the product information and the recording medium information to the selection terminal.

16. The information management method according to claim 15, wherein the selecting includes selecting the selection terminal when used-product information on a used product is received from the second terminal at the second receiving.

17. The information management method according to claim 16, wherein the transmitting includes transmitting the used-product information to the selection terminal before the used product arrives at the selection terminal.

18. The information management method according to claim 15, wherein the selecting includes selecting the recycling base terminal when information on a recording medium detached from a product is received at the second receiving.

19. A computer program product applied to a management terminal that is connected to at least one terminal via a network and comprising a computer usable medium having computer readable program codes embodied in the medium that, when executed, causes a computer to execute:
first receiving product information and recording medium information from a first terminal;
storing information received at the first receiving;
second receiving customer information from a second terminal;
storing information received at the second receiving;
selecting any one of the recycling base terminal and the reproduction base terminal as a selection terminal based on the information stored at the first storing; and
transmitting at least one of the product information and the recording medium information to the selection terminal.

20. A computer-readable recording medium that stores therein a computer program that causes a computer to implement the information management method according to claim 15.
